(19) United States
(12) Patent Application Publication
(10) Pub. No.: US 2013/0154807 A1
(43) Pub. Date: Jun. 20, 2013

(54) METHOD AND APPARATUS FOR DETECTING THE ACTIVATION OF A CALL BUTTON USING RADIO FREQUENCY IDENTIFICATION

(71) Applicants: Robert E. Beach, Los Altos, CA (US); Michael J. Koch, Ft. Salonga, NY (US)

(72) Inventors: Robert E. Beach, Los Altos, CA (US); Michael J. Koch, Ft. Salonga, NY (US)

(73) Assignee: SYMBOL TECHNOLOGIES, INC., Holtsville, NY (US)

(21) Appl. No.: 13/329,738

(22) Filed: Dec. 19, 2011

(51) Int. Cl. G08C 17/02

(52) U.S. Cl. 340/10.4

(57) ABSTRACT

A call button attached to a Radio Frequency Identification (RFID) tag may be activated to send an alert to appropriate personnel. Direct current voltage is received at an input of a RFID tag. Responsive to a query of an RFID reader, the RFID tag detects a state of the call button based on a level of the direct current voltage present at the input of the RFID tag. The RFID tag sends the detected state of the call button to the reader. A signal is sent from a server based on a reported state of the call button.

### FIELD OF THE DISCLOSURE

The present disclosure relates generally to detecting the activation of a call button, and more particularly to detecting the activation when the call button is attached to a Radio Frequency Identification (RFID) tag.

### BACKGROUND

A call button is typically used to send an alert. Call buttons are typically connected to a host computer system through a direct wire or through a wired or wireless network. When a wireless connected call button is pressed/activated, a signal is sent from a radio attached to the call button to a computer system. Often this wireless connection is implemented in accordance with the Institute of Electrical and Electronics Engineers (IEEE) 802.11 standards. Any IEEE standards or specifications referred to herein may be obtained at IEEE, 445 Hoes Lane, PO Box 1331, Piscataway, N.J. 08855-1331, USA. The computer system forwards the information to an appropriate personal. Call buttons are used in a variety of ways. For example, the call button may be placed in close proximity to a hospital bed to enable a patient to alert a health care staff member in another location of the hospital of the patient's need for help. A customer in a retail establishment may also use a call button to alert sales associates in other locations of the retail establishment that the customer needs assistance. A call button may also be used in a manufacturing facility to send an alert when an abnormal condition occurs during a manufacturing process.

In current implementations of the call button, the radio attached to the call button requires a constant supply of power in order to detect when the call button is activated so that the radio can send the Wireless Fidelity (Wi-Fi) activation signal to the computer system. The power source for the radio attached to the call button may be, for example, a number of batteries. In some applications, the radio may include four to six alkaline D-cell batteries. To maintain the power supply to the radio and call button, these batteries will have to be replaced on a regular basis. The cost of supplying power to a call button in an establishment increases with the number of call buttons being implemented.

Accordingly, there is a need for another method and apparatus for detecting the activation of a call button without the associated power supply cost.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a RFID system used in accordance with some embodiments.

FIG. 2 is a block diagram of a RFID reader used in accordance with some embodiments.

FIG. 3 is a block diagram of a RFID tag used in accordance with some embodiments.

FIG. 4 is a block diagram of a call button system used in accordance with some embodiments.

FIG. 5 is a flow diagram of a method used in detecting activation of a call button in accordance with some embodiments.

FIG. 6 is another block diagram of a call button system used in accordance with some embodiments.

FIG. 7 is another flow diagram of a method used in detecting activation of a call button in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to methods and apparatuses for detecting activation of a call button. Direct current voltage is received at an input of a RFID tag. Responsive to a query of an RFID reader, the RFID tag detects a state of the call button based on a level of the direct current voltage present at the input of the RFID tag. The RFID tag sends the detected state of the call button to the RFID reader.

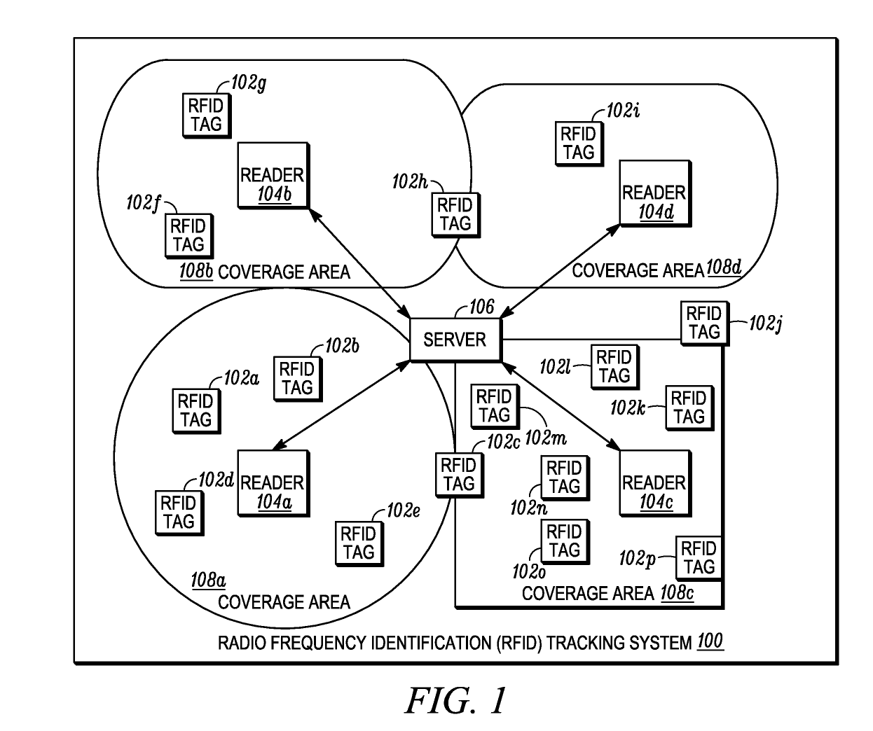

FIG. 1 is a block diagram of a RFID system used in accordance with some embodiments. The RFID system 100 includes at least one RFID reader 104 (also referred to herein as a reader 104), each of which is configured to send and receive radio frequency (RF) signals within a coverage area 108. The readers 104 may operate independently or may be coupled together to form a reader network. Each reader 104 is also configured to communicate with one or more RFID tags 102 (also referred to herein as a tag 102), within its predefined coverage area. The RFID tags 102 can be affixed or attached to one or more items. Each reader 104 may interrogate the tags 102 within its coverage area 108 by transmitting an interrogation signal. The tags 102 within the reader's coverage area may transmit one or more response signals to the reader in a variety of ways, including by alternatively reflecting and absorbing portions of the interrogation signal according to a time-based pattern or frequency.

Each RFID tag 102 may convey information about an individual item or type of item to which the tag is attached or affixed. For example, a RFID tag 102 may be affixed or attached to a call button. The RFID tag 102 can therefore provide information sufficient for determining the state of a call button in an establishment. After receiving a response signal from the tag 102, the reader 104 transmits data obtained from the tag 102 to a server 106. The server 106 may use information received from the tag 102 to send an alert to the appropriate personal in an establishment.

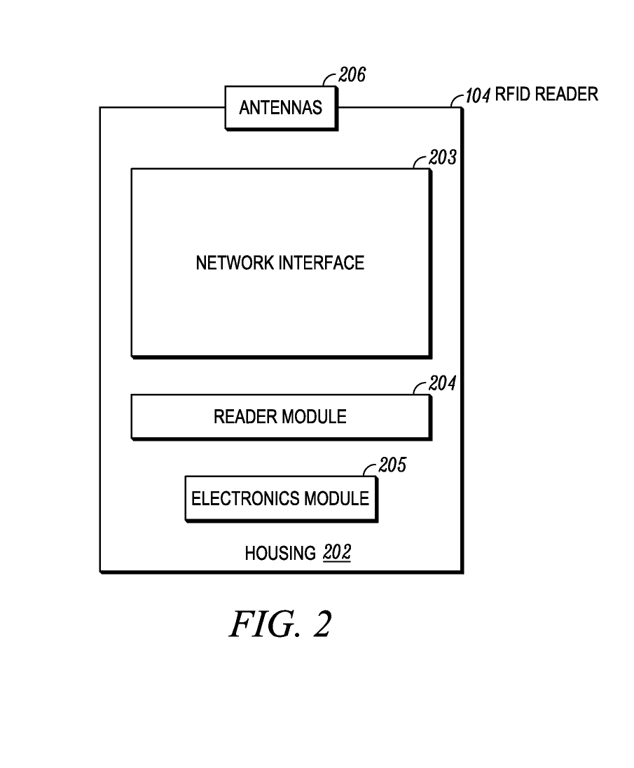

FIG. 2 is a block diagram of a RFID reader used in accordance with some embodiments. The RFID reader 104 generally includes a housing 202, a network interface 203 contained within the housing 202, an RFID reader module 204 contained within the housing 202, an electronics module 205 contained within the housing 202, and one or more RFID antennas 206 (which can be, but are not necessarily, contained within the housing 202). The network interface 203 may be configured to communicate with one or more wireless or wired network devices. In some embodiments, the electronics module 205 can be physically realized as an integrated component, board, card, or package mounted within the housing 202. The electronics module 205 may include one or more memory portions for storing instructions, wherein one or more of the memory portions are coupled to one or more processors for performing functions associated with the RFID reader 104. The RFID reader module 204 can be coupled to the RFID antenna 206 using suitable techniques. For example, the reader module 204 and the RFID antenna 206 can be connected via an RF cable and RF connector assemblies. The RFID reader module 204 may be configured to send RF signals to and receive RF signals from a tag in the reader's coverage area.

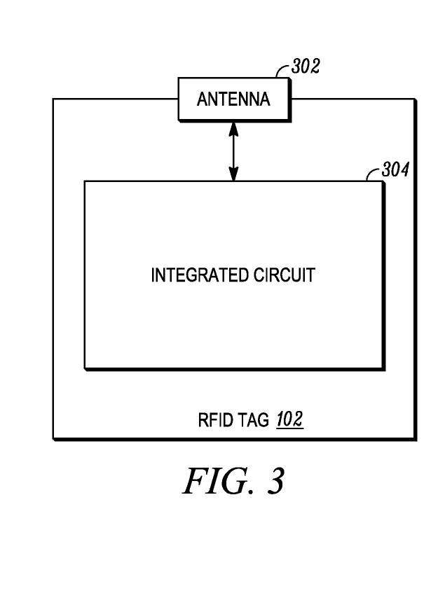

FIG. 3 is a block diagram of a RFID tag used in accordance with some embodiments. The RFID tag 102 includes an antenna 302 and an integrated circuit 304. The antenna 302 is configured to receive and transmit RF signals. The integrated circuit 304 is configured to store and process information. The RFID tag 102 can be positioned within transmission range of the RFID reader 104. Accordingly, the RFID tag 102 can receive an interrogation signal sent from the RFID reader 104 with the antenna 302. The integrated circuit 304 can perform one or more operations in response to receiving the interrogation signal, including modulating the interrogation signal. The integrated circuit 304 can have additional functions such as inputs from sensors or other circuits. After processing the interrogation signal, the RFID tag 102 can transmit a response signal to the RFID reader 104 through the antenna 302. Upon receipt of the response signal, the RFID reader 104 may extract information from the response signal and transmit the extracted information to the server 106. Information from the RFID tag may include identity information or information regarding the state of sensors or circuits coupled to the RFID tag.

In general, a RFID tag 102 can be classified as an active tag or a passive tag, or a combination thereof, depending on how the signal is induced in the RFID tag. An active tag includes an internal power source to continuously power its RF communication circuitry. A passive tag, on the other hand, does not have an internal power source but relies on external sources to stimulate signal transmission. For example, a passive tag may obtain the power required to simulate signal transmission from interrogation signals sent from the reader. An active tag is typically larger and more expensive than a passive tag at least because of the added power source in the active tag.

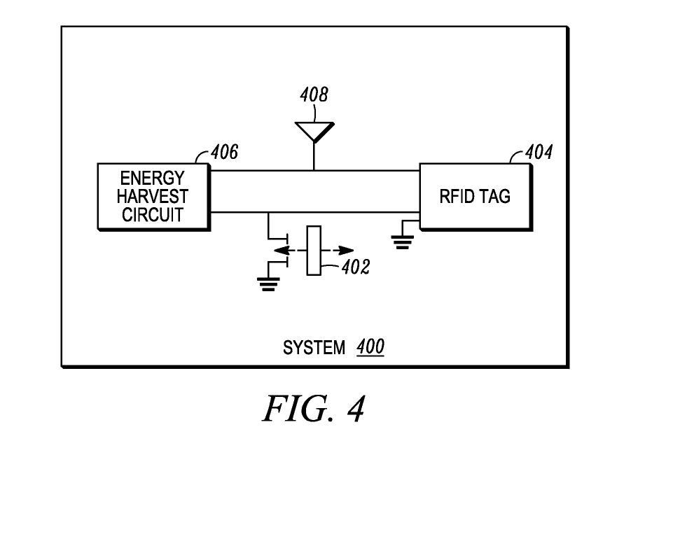

FIG. 4 is a block diagram of a call button system used in accordance with some embodiments. The system 400 includes a remote call button 402, a passive RFID tag 404, an energy harvest circuit 406 and an antenna 408. The call button 402 may be any button or switch that can be pressed/activated to show a state. For example, when the call button 402 is pressed/activated, the state of the call button may indicate a low state, and when the call button 402 is not activated, the state of the call button 402 may indicate a high state. The RFID tag 404 is the same, or substantially similar, as RFID tag 102 shown in FIG. 1, and the RFID tag 404 is configured to sense the state of the call button 402. The energy harvest circuit 406 is configured to hold energy for a predetermined time period. In some embodiments, the energy harvest circuit 406 may include a diode and a capacitor. The energy harvest circuit 406 may also include a resistor to create a time constant. The antenna 408 is configured to charge the energy harvest circuit 406 with ambient RF energy obtained, for example, from interrogations signals sent from the RFID reader to the RFID tag 404.

In use, the energy harvest circuit 406 may collect ambient RF energy through the antenna 408. The energy harvest circuit 406 feeds a direct current voltage created from the collected energy to the RFID tag 404. When the call button 402 is pressed/activated, the energy stored in the energy harvest circuit 406 is depleted and the direct current voltage present at the input to the RFID tag 404 is reduced. In some embodiments, the direct current voltage present at the input to the RFID tag 404 may be reduced to approximately zero volts. Thereafter, when a RFID reader periodically queries the RFID tag 404 to determine the state of the call button 402, the RFID tag 404 is configured to determine the amount of direct current voltage present at its input, set an internal bit that is associated with the amount of direct current voltage (herein referred to as an internal state bit), and send information about the internal state bit to the RFID reader 104. For example, the RFID tag 404 may send its identifier and the value of the internal state bit, wherein the value of the internal state bit corresponds to the amount of direct current voltage present at the input of RFID tag 404 and corresponds to the current state of the call button 402. The RFID reader 104 sends the internal state bit value and other information received from the RFID tag 404 to the server 106. Using the value of the internal state bit from the RFID tag 404, the server 106 determines that the call button 402 has been pressed/activated and forwards the information to an appropriate personal.

Releasing/deactivating the call button 402 reenergizes the energy harvest circuit 406 after a predetermined time constant and increases the direct current voltage present at the input to the RFID tag 404. If the RFID tag 404 is interrogated by the reader 104 during this period when the direct current voltage present at the input to the RFID tag 404 goes above a predefined level, the RFID tag 404 is configured to determine that the amount of direct current voltage present at its input is high, set the internal state bit to reflect the high voltage present at its input, and send the internal state bit that reflects the current state of the call button 402 to the RFID reader 104. The RFID reader 104 then sends the value of the internal state bit and other information received from the RFID tag 404 to the server 106 and the server 106 determines that the call button 402 has not been activated based on the value of the internal state bit. The time constant of the energy harvest circuit 406, as well as a threshold level where the RFID tag 404 senses that the call button 402 is pressed/activated, determine the maximum time between successive interrogations of the RFID tag 404 by the RFID reader 104, and still successfully determine when the call button 402 has been pressed/activated. For example, if the energy harvest circuit 406 reenergizes after thirty seconds, the RFID reader 104 must interrogate the RFID tag 404 in a time period that is less than thirty seconds, for example, in twenty five seconds, to successfully determine whether the call button 402 has been pressed/activated.

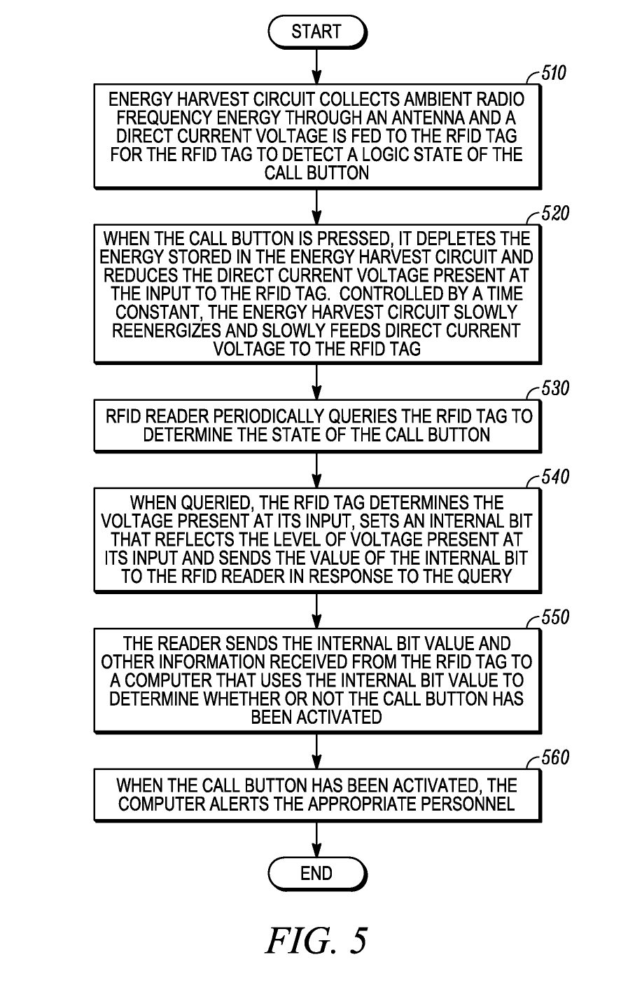

FIG. 5 is a flow diagram of a method used in detecting the activation of the call button in accordance with some embodiments. In 510, the energy harvest circuit collects ambient RF energy through an antenna and a direct current voltage is fed to the RFID tag. In 520, when the call button is pressed/activated, the energy stored in the energy harvest circuit is depleted and the direct current voltage present at the input to the RFID tag is reduced. Controlled by a time constant, the energy harvest circuit slowly reenergizes and slowly feeds direct current voltage to the RFID tag. In 530, an RFID reader periodically queries the RFID tag in less time than the time constant to determine the state of the call button. In 540, when queried, the RFID tag determines the voltage present at its input, sets an internal bit that reflects the level of voltage present at its input and sends the value of the internal bit to the RFID reader in response to the query. In 550, the RFID reader sends the internal bit value and other information received from the RFID tag to a computer that uses the value of the internal bit to determine whether or not the call button has been pressed/activated. In 560, when the call button has been pressed/activated, the computer alerts the appropriate personnel.

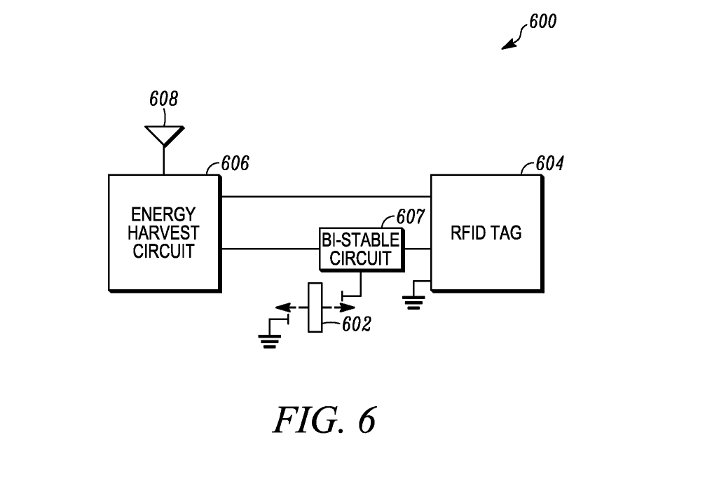

FIG. 6 is another block diagram of a call button system used in accordance with some embodiments. The system 600 includes a remote call button 602, an RFID tag 604, an energy harvest circuit 606, at least one bi-stable circuit 607 and an antenna 608. The call button 602 may be any button that can be pressed/activated to show a state. For example, when the call button 602 is activated, it may be associated with a high state and when call button 602 is not activated, it may be associated with a low state, or vice versa as shown in FIG. 6. RFID tag 604 is configured to sense the state of the call button 602. The energy harvest circuit 606 is configured to hold energy. The energy harvest circuit 606 creates and inputs a state value to the bi-stable circuit 607, wherein the state value reflects the state of the call button 602. The antenna 608 is configured to charge the energy harvest circuit 606 with ambient RF energy obtained, for example, from interrogations signals sent from the RFID reader to the RFID tag 604.

The RFID tag 604 is also connected to the bi-stable circuit 607. When the call button 602 is pressed/activated, the energy harvest circuit 606 updates the state value inputted to the bi-stable circuit 607. For example, the state value inputted to the bi-stable circuit 607 could switch from “off” when the call button is not activated to “on” when the called button is activated, or vice versa. In these embodiments, the pressed/activated call button may or may not deplete the energy stored in the energy harvest circuit 606 and may or may not reduce the direct current voltage present at the input of the RFID tag 604. When the RFID reader 104 periodically queries the RFID tag 604 to determine the state of the call button 602, the RFID tag 604 is configured to obtain the current state value from the bi-stable circuit 607 and send the current state value to the RFID reader 104. The reader 104 then sends the state value and other information received from the RFID tag 604 to the server 106. Using this value, the server 106 determines that the call button 602 has been pressed/activated and forwards the information to an appropriate personal.

In these embodiments, the RFID tag may be an active tag or a passive tag. The state of the bi-stable circuit 607 may be automatically reset to reflect that the call button is not activated when the RFID tag 604 is interrogated. Other embodiments using the bi-stable circuit 607 may not include the energy harvest circuit 606. In these embodiments, when the call button is pressed/activated, the call button sends its state value directly to the bi-stable circuit 607. In some implementations, the bi-stable circuit 607 may include a counter to count the number of times a call button is activated. There may also be more than one bi-stable circuits 607 to reflect the states of multiple call buttons.

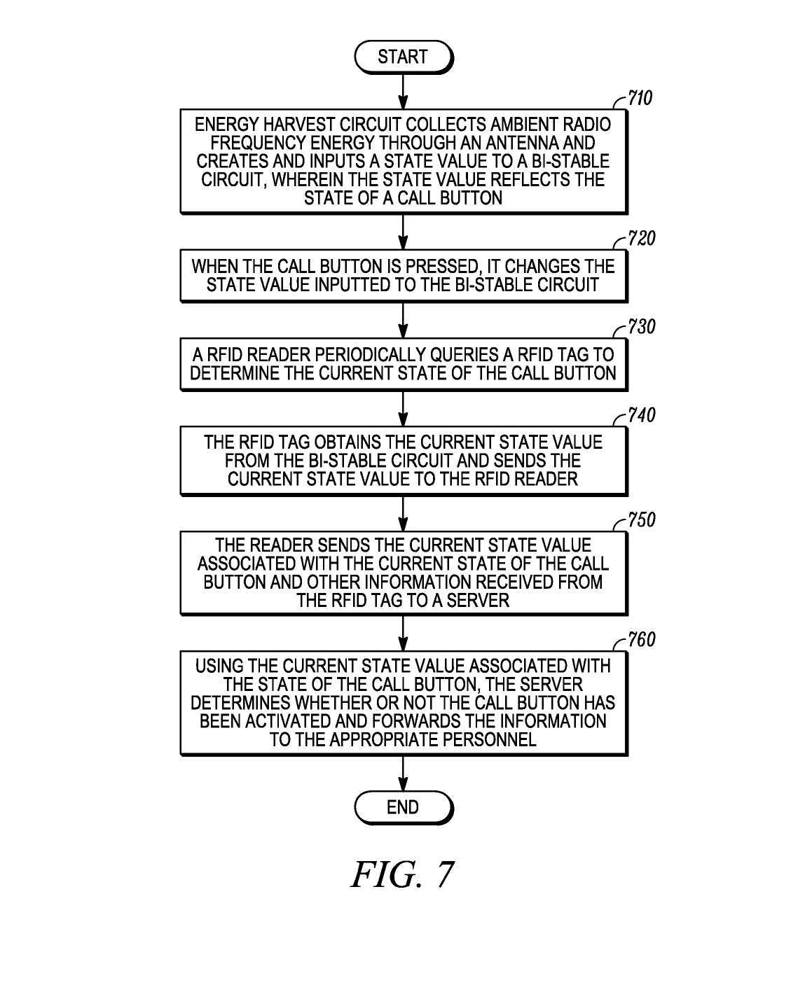

FIG. 7 is a flow diagram of another method used in detecting the activation of the call button in accordance with some embodiments. In 710, the energy harvest circuit collects ambient RF energy through an antenna and creates and inputs a state value to a bi-stable circuit, wherein the state value reflects the state of a call button. In 720, when the call button is pressed/activated, it changes the state value inputted to the bi-stable circuit. In 730, a RFID reader periodically queries a RFID tag to determine the current state of the call button. In 740, the RFID tag obtains the current state value from the bi-stable circuit and sends the current state value to the RFID reader. In 750, the reader sends the current state value associated with the current state of the call button and other information received from the RFID tag to a server. In 760, using the current state value associated with the state of the call button, the server determines whether or not the call button has been activated and forwards the information to the appropriate personnel.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method in a Radio Frequency Identification (RFID) tag of detecting activation of a call button, the method comprising:
receiving a direct current voltage at an input of the RFID tag;
responsive to a query of an RFID reader, detecting a state of the call button based on a level of the direct current voltage present at the input of the RFID tag; and
sending the detected state of the call button to the RFID reader, wherein a signal is sent based on a reported state of the call button.

2. The method of claim 1, wherein the direct current voltage is fed to the input of the RFID tag from ambient radio frequency energy collected in an energy harvest circuit attached to the RFID tag.

3. The method of claim 1, wherein when the call button is activated, the call button depletes energy stored in a connected energy harvest circuit and reduces the direct current voltage present at the input of the RFID tag, wherein the detecting comprises detecting that the call button is activated based on a reduced amount of direct current voltage at the input of the RFID tag.

4. The method of claim 1, wherein the detecting comprises detecting that the call button has not been activated based on an amount of direct current voltage at the input of the RFID tag.

5. The method of claim 1, wherein the direct current voltage at the input of the RFID tag increases during a predefined time constant after an activated call button is deactivated.

6. A method in a Radio Frequency Identification (RFID) tag of detecting activation of a call button, the method comprising:
responsive to a query of an RFID reader, detecting a state of the call button based on a state obtained from at least one bi-stable circuit connected to the RFID tag, wherein when the call button is activated the state of a bi-stable circuit associated with the call button is updated to reflect that the call button has been activated; and
sending the detected state of the call button to the RFID reader, wherein a signal is sent based on a reported state of the call button.

7. The method of claim 6, wherein the detecting comprises detecting that the call button is activated when the state of the bi-stable circuit is set to a predefined value.

8. The method of claim 6, wherein the detecting comprises detecting a number of times the call button has been activated based on information received from at least one bi-stable circuit.

9. A system for detecting activation of a call button attached to a Radio Frequency Identification (RFID) tag, the system comprises:
an energy harvest circuit energized from ambient radio frequency energy, wherein the energy harvest circuit is configured to feed a direct current voltage from the ambient radio frequency energy to an input of the RFID tag;
the call button configured to change voltage present at the input of the RFID tag when the call button is activated; and
the RFID tag configured to detect, in response to a query from a reader, a state of the call button based on a level of the direct current voltage present at the input of the RFID tag and to send the detected state of the call button to the reader, wherein a signal is sent based on a reported state of the call button.

10. The system of claim 9, wherein when the call button is activated the call button depletes energy stored in the energy harvest circuit and reduces the direct current voltage present at the input of the RFID tag, wherein the RFID tag is configured to detect that the call button is activated based on a reduced amount of direct current voltage at the input of the RFID tag.

11. The system of claim 9, wherein the RFID tag is configured to detect that the call button is activated based on an amount of direct current voltage at the input of the RFID tag.

12. The system of claim 9, wherein the direct current voltage at the input of the RFID tag increases during a predefined time constant after call button is deactivated.

13. The system of claim 9, further comprising an antenna configured to retrieve ambient radio frequency energy and to feed the retrieved ambient radio frequency energy to the energy harvest circuit.

14. A system for detecting activation of a call button attached to a Radio Frequency Identification (RFID) tag, the system comprises:
a bi-stable circuit configured to store a current state of the call button; and
the RFID tag configured to detect, in response to a query from a reader, the current state of the call button based on a state value obtained from the bi-stable circuit, wherein when the call button is activated, the state value obtained from the bi-stable circuit is updated to reflect that the call button has been activated, wherein the RFID tag is configured to send the detected state of the call button to the reader, and wherein a signal is sent based on a reported state of the call button.

15. The system of claim 14, further comprising an antenna configured to retrieve ambient radio frequency energy and to feed the retrieved ambient radio frequency energy to an energy harvest circuit.

16. The system of claim 14, further comprising an energy harvest circuit configured to collect ambient radio frequency energy and feed a direct current voltage from collected ambient radio frequency energy to an input of the RFID tag.

17. The system of claim 14, wherein the RFID tag is configured to detect that the call button is activated when the state of the bi-stable circuit is set to a predefined value.

18. The system of claim 14, wherein the RFID tag is configured to detect a number of times the call button has been activated based on information received from at least one bi-stable circuit.
